(19) United States
(12) Patent Application Publication
(10) Pub. No.: US 2006/0110518 A1
(43) Pub. Date: May 25, 2006

(54) Unique method of baking Parmesan cheese and creating a variety of resulting products

(76) Inventor: Patrick Thompson, Rancho Santa Margarita, CA (US)

Correspondence Address: ERIC HANSCOM, 7395 PORTAGE WAY, CARLSBAD, CA, 92011, US

(21) Appl. No.: 10/996,556

(22) Filed: Nov. 23, 2004

(51) Int. Cl. A23C 19/00

(52) U.S. Cl. 426/582

(57) ABSTRACT

This invention is directed toward a new snack food made from Parmesan cheese, and a method of making the same. The invention teaches a baking process by which Parmesan cheese is baked within a specific temperature range for a specified period of time. The resulting product can then be eaten as al low-fat snack, or molded into plates, bowls and other eating dishes, thereby creating edible dishes from which other food can be eaten.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

This invention is directed toward a new snack food made from Parmesan cheese, and a method of making the same. The invention teaches a baking process by which Parmesan cheese is baked within a specific temperature range for a specified period of time. The resulting product can then be eaten as al low-fat snack, or molded into plates, bowls and other eating dishes, thereby creating edible dishes from which other food can be eaten.

People have been enjoying Parmesan cheese, named for he Italian town of Parma were it is thought to have originated, for around 2,000 years. An old Italian legend tells a tale that near town of Parma there lay a huge mountain which had been made from grated Parmesan cheese. On the mountaintop was a macaroni factory which, after preparing the hot pasta would bathe it in butter, then roll it down the mountain to the hungry townspeople waiting below. Although this myth is obviously a fairly tale, few people can listen to the story and not salivate at the thought of an endless supply of Parmesan-coasted pasta prepared in this unique manner.

Over the ensuing 2,000 years, chefs, first in Italy and by the 1300's throughout the rest of Europe, began experimenting with different ways to use this delicious cheese in a variety of ways. With trade eventually opening up to Asia and the New World, by the 1700's Parmesan cheese had crossed the globe and was being used as a snack, side dish, and flavoring on six of the seven continents. Over the past several decades, however, there has been substantial concern over the fat content of cheeses, including Parmesan cheese, which has resulted in numerous attempts to produce “low-fat” Parmesan cheese which did not taste like flavored cardboard or one of the other urban legend insults frequently leveled against a low-fat version of a classic food.

The prior art discloses a number of inventions directed toward producing cheese products, many of them low-fat, however none of them produce the product in as simple a manner as this invention, nor does any of the prior art suggest the use of dried cheese for use as edible bowls, plates, and other dishes. For example, U.S. Pat. Nos. 5,080,913, 5,225,220, 5,395,630, 5,549,916 to Gamay, U.S. Pat. No. 5,227,187 to Wiser, U.S. Pat. No. 5,080,912 to Bodenstein, and U.S. Pat. No. 4,994,296 to Kiniczky all teach methods of making or processing cheese, but all involve fairly complex controls over things like pH, addition of clotting enzymes, the use of complex mechanical processes, or the addition of numerous other additives at various stages of the manufacturing process. These complex controls and addition limitations are not present in the current invention, which is a relatively simple process of cooking aged Parmesan cheese for a certain period of time at a certain temperature.

Other prior art includes U.S. Pat. No. 5,258,196 to Lohan, which deals with the preparation for a pasta chip, and U.S. Pat. No. 4,960,605 to Trecker, which teaches a method of drying Parmesan cheese and preparing it for grating. While both of these patens adequately disclose unique methods of preparation of foodstuffs, neither anticipates applicant's unique product or method of production.

Applicant's invention also discloses a process by which the low-fat Parmesan cheese product of the initial baking can be molded into edible products with distinctive shapes, including potato

Thus, there has existed a long-felt need for a low-fat Parmesan food snack with a long shelf life. The current invention provides just such a solution by teaching a baking method by which specific quantities of aged Parmesan cheese can be baked with a specified temperature range for a specified time period, with the resulting product being low-fat compared with raw Parmesan cheese, and having a much longer shelf life than raw Parmesan cheese. This invention additionally provides a method by which this low-fat Parmesan cheese product can be produced as snack food, or as edible plates and bowls, thereby creating a unique and tasty dining experience.

### SUMMARY OF THE INVENTION

It is a principal object of the invention to provide a method by which off-the-shelf aged Parmesan cheese can be used to produce a low-fat Parmesan cheese product with a long shelf life.

It is a further object of the invention to provide a method by which the resulting baked Parmesan cheese product can be produced as a snack food.

It is an additional object of the invention to provide a method by which the resulting baked Parmesan cheese product can be produced as edible plates, bowls and other serving dishes.

What I claim is:

1. A method for producing a low-fat food product from Parmesan cheese, comprising the steps of:
taking a specific quantity of dry, aged, Parmesan cheese,
shredding the Parmesan cheese through a hand or mechanical shredding device,
preparing a flat sheet upon which the Parmesan cheese is to be baked,
spreading the Parmesan cheese on the flat sheet in a thin layer sufficiently wide enough to create a desired eventual shape,
inserting the flat sheet in an oven,
baking the Parmesan cheese in the oven within a temperature range for a set period of time,
removing the baked Parmesan cheese from the oven,
optionally molding it into the desired eventual shape, and
allowing it to cool to room temperature.

2. The method of claim 1, where,
the temperature range is between 450 and 475 degrees.

3. The device of claim 2, where,
the desired eventual shape is a thin, flat, crispy, wafer-like piece of Parmesan cheese the approximate size and shape of a potato chip and the desired shape is created by placing a thin layer of shredded Parmesan cheese on the flat sheet, baking it at the temperature range of between 450 and 475 degrees with the set period of time of between three and four minutes, where the baked Parmesan cheese is allowed to cool on the flat sheet.

4. The device of claim 2, where,
the desired eventual shape is a thin, crispy piece of Parmesan cheese that has been molded into the shape of a bowl, plate, or other dish, where, the bowl, plate, or other eating device can be consumed by the purchaser or user of the product, and where a quantity of shredded parmesan cheese sufficient to create a piece of cheese of a large enough diameter to create the desired bowl, plate, or other dish is baked on the flat sheet, after which the baked Parmesan cheese is removed from the oven before it has completely cooled and draped over a bowl, plate, or other dish and allowed to cool completely, thereby solidifying and taking on the shape of the bowl, plate, or other dish.

5. The method of claim 1, where,
The set period of time is between three and four minutes

6. The device of claim 5, where,
the desired eventual shape is a thin, flat, crispy, wafer-like piece of Parmesan cheese the approximate size and shape of a potato chip and the desired shape is created by placing a thin layer of shredded Parmesan cheese on the flat sheet, baking it at the temperature range of between 450 and 475 degrees with the set period of time of between three and four minutes, where the baked Parmesan cheese is allowed to cool on the flat sheet.

7. The device of claim 5, where,
the desired eventual shape is a thin, crispy piece of Parmesan cheese that has been molded into the shape of a bowl, plate, or other dish, where, the bowl, plate, or other eating device can be consumed by the purchaser or user of the product, and where a quantity of shredded parmesan cheese sufficient to create a piece of cheese of a large enough diameter to create the desired bowl, plate, or other dish is baked on the flat sheet, after which the baked Parmesan cheese is removed from the oven before it has completely cooled and draped over a bowl, plate, or other dish and allowed to cool completely, thereby solidifying and taking on the shape of the bowl, plate, or other dish.

8. The method of claim 1, where,
the temperature range is between 450 and 475 degrees and the set period of time is between three and four minutes.

9. The device of claim 8, where,
the desired eventual shape is a thin, flat, crispy, wafer-like piece of Parmesan cheese the approximate size and shape of a potato chip and the desired shape is created by placing a thin layer of shredded Parmesan cheese on the flat sheet, baking it at the temperature range of between 450 and 475 degrees with the set period of time of between three and four minutes, where the baked Parmesan cheese is allowed to cool on the flat sheet.

10. The device of claim 8, where,
the desired eventual shape is a thin, crispy piece of Parmesan cheese that has been molded into the shape of a bowl, plate, or other dish, where, the bowl, plate, or other eating device can be consumed by the purchaser or user of the product, and where a quantity of shredded parmesan cheese sufficient to create a piece of cheese of a large enough diameter to create the desired bowl, plate, or other dish is baked on the flat sheet, after which the baked Parmesan cheese is removed from the oven before it has completely cooled and draped over a bowl, plate, or other dish and allowed to cool completely, thereby solidifying and taking on the shape of the bowl, plate, or other dish.
